(19) United States
(12) Patent Application Publication
(10) Pub. No.: US 2012/0154350 A1
(43) Pub. Date: Jun. 21, 2012

(54) ACTIVE DEVICE ARRAY SUBSTRATE AND METHOD FOR REDUCING POWER CONSUMPTION

(75) Inventors: Cho-Yu Li, Taoyuan County (TW); Yuan-Hsin Tsou, Kaohsiung City (TW)

(73) Assignee: CHUNGHWA PICTURE TUBES, LTD., Taoyuan (TW)

(21) Appl. No.: 13/034,705

(22) Filed: Feb. 25, 2011

(30) Foreign Application Priority Data
Dec. 17, 2010 (TW) 99144533

(51) Int. Cl. G06F 3/038

(52) U.S. Cl. 345/206

(57) ABSTRACT

An active device array substrate includes a substrate, an active device, a gate driving circuit, and a scan line. A display area and a peripheral circuit area are defined on the substrate. The active device disposed on the substrate is located in the display area. The active device includes a width reduced gate, a source, and a drain. An overlapping area of the source and the width reduced gate of the active device forms a first capacitor. The gate driving circuit disposed on the substrate is located in the peripheral circuit area and includes a pull-up device having a gate, a source, and a width reduced drain. An overlapping area of the width reduced drain and the gate of the pull-up device forms a second capacitor. The scan line disposed on the substrate electrically connects the drain of the pull-up device and the gate of the active device.

### CROSS-REFERENCE TO RELATED APPLICATION

This application claims the priority benefit of Taiwan application serial no. 99144533, filed on Dec. 17, 2010. The entirety of the above-mentioned patent application is hereby incorporated by reference herein and made a part of this specification.

### BACKGROUND OF THE INVENTION

1. Field of the Invention

The present invention generally relates to an array substrate and a method for reducing power consumption, in particular, to an active device array substrate and a method for reducing power consumption.

2. Description of Related Art

In order to pass a severe high or low temperature environmental test, a gate in panel (GIP) Stage circuit in the prior art generally strengthens the output capability of the GIP Stage as much as possible at the beginning of design.

However, with the strengthening of the output capability of the GIP Stage, such as strengthening of the output capability for influencing a pull-up device for GIP Output, the power consumption of the GIP Stage circuit is also increased accordingly. In other words, if the GIP circuit is applied to a panel of a notebook computer, the power consumption thereof generally becomes one of specifications strictly required by a client. Therefore, if the design of the pull-up device in the prior art is adopted, the specification may be exceeded due to excessively large power consumption and the shipment cannot be performed. In this way, materials after the Cell stage are wasted, which generally can only be compensated through the mask modification, so the mask modification cost is incurred.

### SUMMARY OF THE INVENTION

Accordingly, the present invention is directed to an active device array substrate with low power consumption, and a method for reducing power consumption, which is applicable to the foregoing active device array substrate.

The present invention provides an active device array substrate, which includes a substrate, at least one active device, a gate driving circuit, and at least one scan line. A display area and a peripheral circuit area are defined on the substrate. The active device is disposed on the substrate and is located in the display area. The active device includes a width reduced gate, a source, and a drain, and an overlapping area of the source of the active device and the width reduced gate of the active device forms a first capacitor. The gate driving circuit is disposed on the substrate, and is located in the peripheral circuit area. The gate driving circuit includes at least one pull-up device, and the pull-up device includes a gate, a source, and a width reduced drain, in which an overlapping area of the width reduced drain of the pull-up device and the gate of the pull-up device forms a second capacitor. The scan line is disposed on the substrate and electrically connects the drain of the pull-up device and the gate of the active device.

In an embodiment of the present invention, the overlapping width of the source of the active device and the width reduced gate of the active device is substantially larger than or equal to 60% of the overlapping width of the width reduced drain of the pull-up device and the gate of the pull-up device. Furthermore, the overlapping width of the source of the active device and the width reduced gate of the active device is substantially smaller than or equal to 90% of the overlapping width of the width reduced drain of the pull-up device and the gate of the pull-up device.

In an embodiment of the present invention, the line width of the width reduced gate of the active device substantially falls between 4 μm and 5 μm, while the line width of the width reduced drain of the pull-up device substantially falls between 5 μm and 6 μm.

The present invention further provides an active device array substrate, which includes a substrate, at least one active device, a gate driving circuit, and at least one scan line. A display area and a peripheral circuit area are defined on the substrate. The active device is disposed on the substrate, and is located in the display area. The active device includes a gate, a source, and a drain, and an overlapping area of the source of the active device and the gate of the active device forms a first capacitor. The gate driving circuit is disposed on the substrate, and is located in the peripheral circuit area. The gate driving circuit includes at least one pull-up device, and the pull-up device includes a patterned gate, a source, and a drain, in which an overlapping area of the drain of the pull-up device and the patterned gate of the pull-up device forms a second capacitor. The scan line is disposed on the substrate, and electrically connects the drain of the pull-up device and the gate of the active device. The overlapping width of the source of the active device and the gate of the active device is substantially larger than or equal to 60% of the width of the gate of the active device, and the overlapping width of the source of the active device and the gate of the active device is substantially smaller than or equal to 90% of the width of the gate of the active device.

The present invention further provides a method for reducing power consumption, which is applicable to an active device array substrate. The active device array substrate includes at least one active device and a gate driving circuit. The active device is located in a display area of the active device array substrate, while the gate driving circuit is located in a peripheral circuit area of the active device array substrate. The active device includes a gate, a source, and a drain. An overlapping area of the source of the active device and the gate of the active device forms a first capacitor. The gate driving circuit includes at least one pull-up device, and the pull-up device includes a gate, a source, and a drain, in which an overlapping area of the drain of the pull-up device and the gate of the pull-up device forms a second capacitor. The method for reducing power consumption includes the following steps. Firstly, the overlapping area of the drain of the pull-up device and the gate of the pull-up device is reduced, so as to reduce the capacitance of the second capacitor. Then, the overlapping area of the source of the active device and the gate of the active device is reduced, so as to reduce the capacitance of the first capacitor.

In an embodiment of the present invention, the method of reducing the overlapping area of the drain of the pull-up device and the gate of the pull-up device includes: reducing the line width of the drain of the pull-up device. In an embodiment of the present invention, the method of reducing the overlapping area of the source of the active device and the gate of the active device includes: reducing the line width of the gate of the active device. In an embodiment of the present invention, the overlapping width of the source of the active device and the gate of the active device is substantially larger than or equal to 60% of the overlapping width of the drain of the pull-up device and the gate of the pull-up device, and the overlapping width of the source of the active device and the gate of the active device is substantially smaller than or equal to 90% of the overlapping width of the drain of the pull-up device and the gate of the pull-up device.

In an embodiment of the present invention, the method of reducing the overlapping area of the drain of the pull-up device and the gate of the pull-up device includes: removing a part of the gate of the pull-up device, so as to reduce the overlapping area of the drain of the pull-up device and the gate of the pull-up device.

In an embodiment of the present invention, the method of reducing the overlapping area of the source of the active device and the gate of the active device includes: reducing the line width of the gate of the active device, or reducing the overlapping area of the source of the active device and the gate of the active device through a patterning process.

In an embodiment of the present invention, the overlapping width of the source of the active device and the gate of the active device is substantially larger than or equal to 60% of the width of the gate of the active device, and the overlapping width of the source of the active device and the gate of the active device is substantially smaller than or equal to 90% of the width of the gate of the active device.

Based on the foregoing, according to the present invention, by reducing a second capacitance value of a pull-up device, overall power consumption of a gate driving circuit can be reduced, and at the same time of reducing the overall power consumption of the gate driving circuit, a capacitance value of a first capacitor of an active device in a display area is reduced, so that the gate driving circuit still can normally drive the active device in the display area. Furthermore, the present invention also provides a method for reducing power consumption, which is applicable to the foregoing active device array substrate.

In order to make the aforementioned features and advantages of the present invention more comprehensible, embodiments are illustrated in detail hereinafter with reference to accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a local schematic view of an active device array substrate according to an embodiment of the present invention.

FIG. 2 is a schematic local circuit diagram of a gate driving circuit in FIG. 1.

FIG. 3A and FIG. 3B are local top views before and after a drain line width of a pull-up device in FIG. 2 is reduced.

FIG. 4 is a local top view of an active device being connected with a scan line in FIG. 1.

FIG. 5A and FIG. 5B are local top views before and after a gate of a pull-up device in FIG. 2 is patterned .

FIG. 6 is a local top view of an active device being connected with a scan line in FIG. 1.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

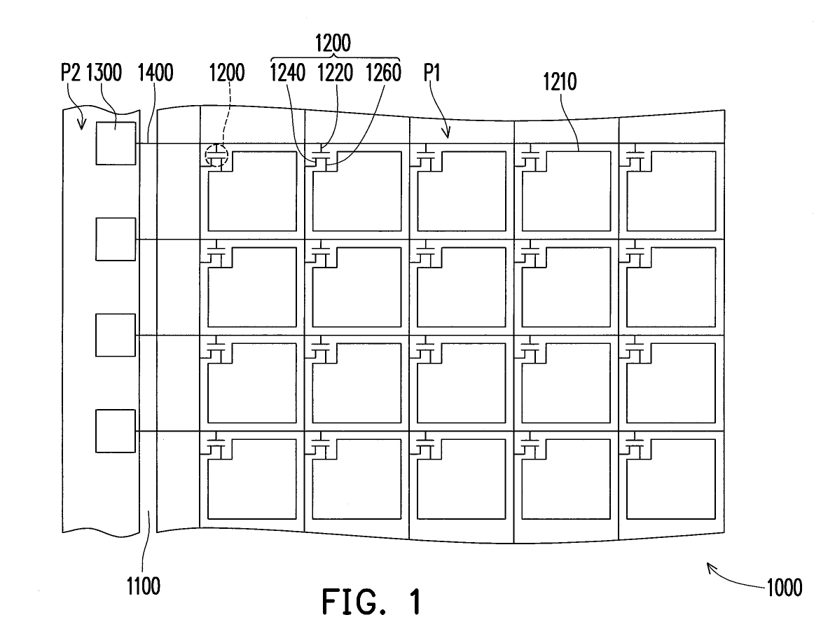

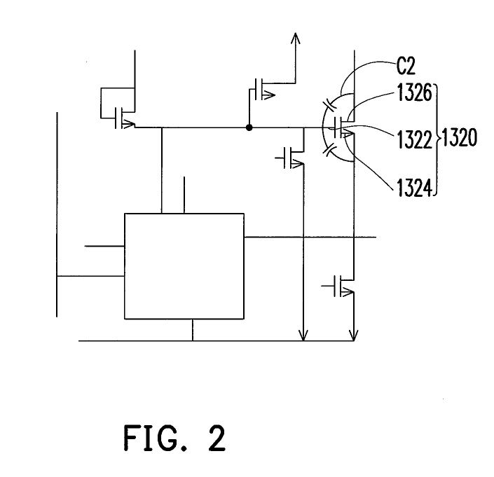

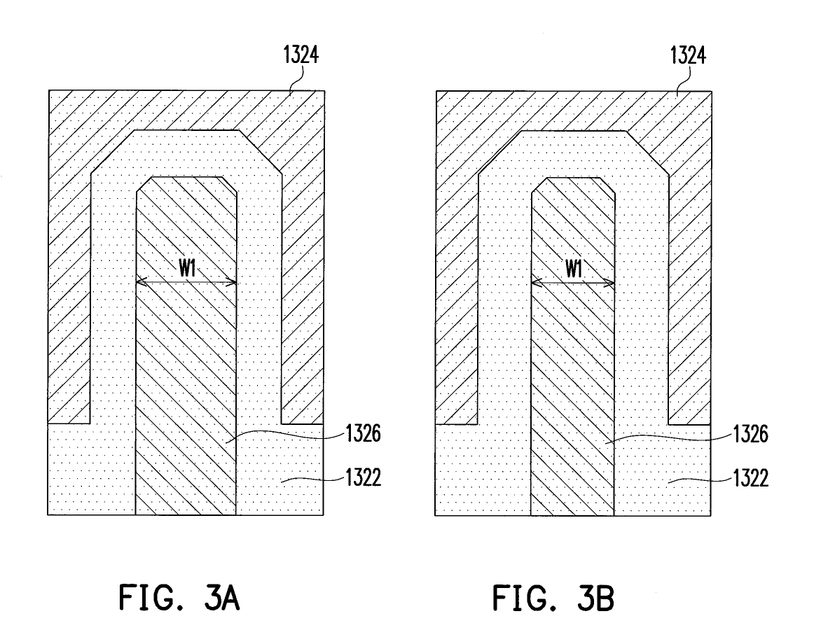

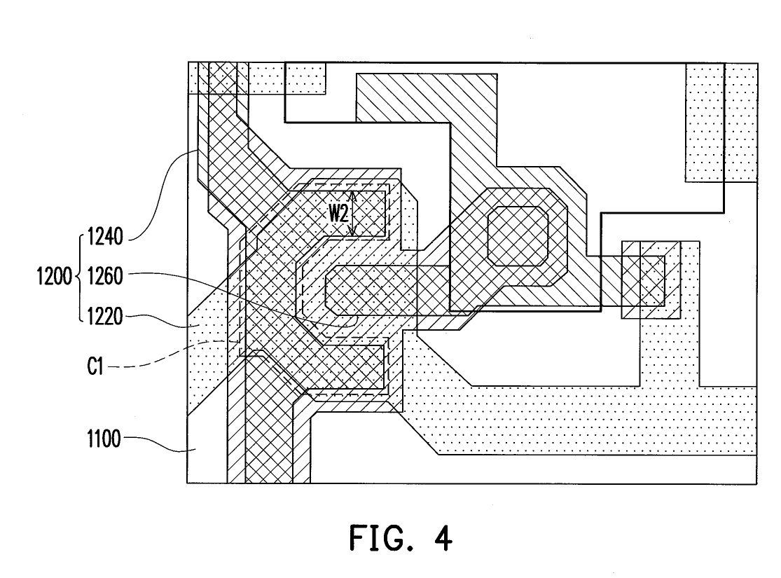

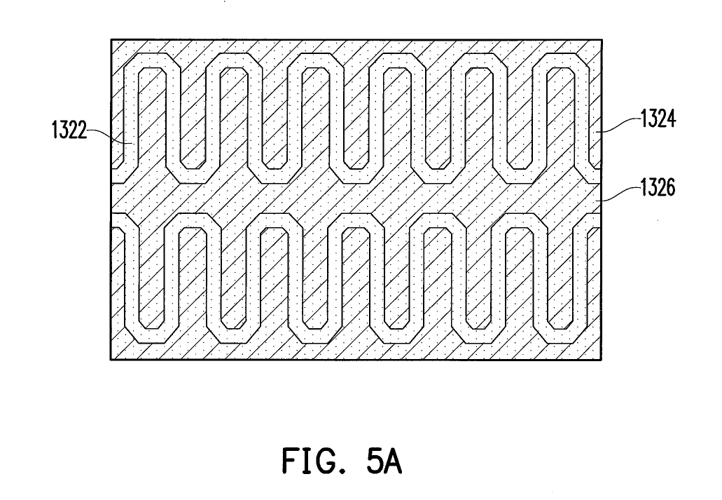

FIG. 1 is a local schematic view of an active device array substrate according to an embodiment of the present invention; FIG. 2 is a schematic local circuit diagram of a gate driving circuit in FIG. 1; FIG. 3A and FIG. 3B are local top views before and after a drain line width of a pull-up device in FIG. 2 is reduced; and FIG. 4 is a local top view of an active device being connected with a scan line in FIG. 1. Referring to FIG. 1, FIG. 2, FIG. 3A, FIG. 3B, and FIG. 4, an active device array substrate 1000 of this embodiment includes a substrate 1100, at least one active device 1200, a gate driving circuit 1300, and at least one scan line 1400.

A display area P1 and a peripheral circuit area P2 are defined on the substrate 1100 of this embodiment, and the substrate 1100 may be a glass substrate or other appropriate substrates, as shown in FIG. 1. The active device 1200 is disposed on the substrate 1100, and is located in the display area P1, as shown in FIG. 1 and FIG. 4. In this embodiment, the active device 1200 includes a width reduced gate 1220, a source 1240, and a drain 1260, and an overlapping area of the source 1240 of the active device 1200 and the width reduced gate 1220 of the active device 1200 forms a first capacitor.

Specifically, in this embodiment, an array of multiple active devices 1200 is used as an example for illustration, as shown in FIG. 1, and each active device 1200 controls a transparent electrode 1210 in a pixel. That is to say, the active device array substrate 1000 of this embodiment for example is a thin film transistor array substrate used for a liquid crystal display panel. It is noted that, the active device array substrate 1000 of this embodiment adopts the design of GIP, that is, the gate driving circuit 1300 is manufactured on the substrate 1100. The gate driving circuit 1300 is illustrated hereinafter, and a relative relationship between the gate driving circuit 1300 and the active device 1200 is further illustrated.

Referring to FIG. 1, FIG. 2, FIG. 3A, and FIG. 3B, the gate driving circuit 1300 is disposed on the substrate 1100, and is located in the peripheral circuit area P2. In this embodiment, the gate driving circuit 1300 includes at least one pull-up device 1320, and the pull-up device 1320 includes a gate 1322, a source 1324, and a width reduced drain 1326, in which an overlapping area of the width reduced drain 1326 of the pull-up device 1320 and the gate 1322 of the pull-up device 1320 forms a second capacitor C2.

Specifically, in order to pass a severe high or low temperature environmental test, a conventional GIP Stage circuit generally strengthens the output capability of the GIP Stage as much as possible at the beginning of design, that is, strengthens the output capability of the pull-up device 1320. However, in this way, a problem that the power consumption is increased accordingly is caused. Generally, when the GIP circuit is applied to an NB panel, the power consumption is one of specifications strictly required by the client, and at this time, a conventional pull-up device is designed with a pattern as shown in FIG. 3A. In this way, the specification may be exceeded due to the excessively large power consumption of the pull-up device. Additionally, for the strengthened pull-up device shown in FIG. 3A, a film layer of the gate 1322 is provided below the drain 1326 for improving the equivalent W/L, so in this way the capacitance value of the second capacitor C2 is increased. In other words, according to the first-order RC circuit theory, the power consumed by the RC circuit is CV²F, so after the capacitance value of the second capacitor C2 of the pull-up device is increased, the power consumption is increased accordingly.

Next, according to the first-order RC circuit theory, the power consumed by the RC circuit is CV²F, while the power consumption of the capacitor is ½ CV²F. In other words, no matter how much the resistance is, the power consumption of the capacitor is always ½ CV²F. Therefore, according to the theory, by reducing the overlapping area of the drain 1326 and the gate 1322, the capacitance value of the second capacitor C2 can be reduced, so as to reduce the overall power consumption of the GIP circuit. In this way, although the resistance value R is increased, no additional power consumption is caused.

In this embodiment, the simulation can also be performed through simulation software, and verification is performed with a simulation result. It is known through the simulation result that, when the resistance value R is increased to 200%, while the capacitance value C is reduced to 50%, the gate 1220 of the active device 1200 still can be normally driven by the pull-up device 1320 in the gate driving circuit 1300. In this way, it can be determined that, for the pull-up device 1320, the driving capability of the gate 1220 of the active device 1200 in the display area 130 is mainly affected by the capacitance value, while is less relevant to the resistance.

Based on the foregoing principle, in this embodiment, by reducing the second capacitance value C2 of the pull-up device 1320, the overall power consumption of the gate driving circuit 1300 can be reduced, and the capacitance value of the first capacitor C1 in the display area P1 is reduced at the same time of reducing the overall power consumption of the gate driving circuit 1300, so that the gate driving circuit 1300 still can normally drive the active device 1200 in the display area P1, in which a manner of reducing the capacitance of the first capacitor C1 and the second capacitor C2 is illustrated in the following paragraph.

Referring to FIG. 3A firstly, FIG. 3A is a conventional disposing manner of the source 1324 and the drain 1326, in which the line width W1 of the drain 1326 usually ranges from 6 μm to 7 μm, or is even larger than 7 μm, while the film layer of the gate 1322 is provided below the drain 1326, and in this way the capacitance value is incurred. Therefore, in order to reduce the capacitance value of the second capacitor C2, the width W1 of the drain 1326 may be reduced, as shown in FIG. 3B, in which the reduced width W1 for example is 5 μm. In this way, the overlapping area of the drain 1326 and the gate 1322 is reduced accordingly, so the capacitance value of the second capacitor C2 is reduced, so as to reduce the overall power consumption of the gate driving circuit 1300.

Then, the capacitance value of the second capacitor C2 is reduced, so in order to enable the gate driving circuit 1300 to smoothly drive the active device 1200 in the display area P1, by reducing the capacitance value of the first capacitor C1 between the gate 1220 (or a gate line) and the source 1240, the output demands for driving the active device 1200 can be reduced, which is illustrated in detail as follows.

In FIG. 4, by reducing the line width or the width W2 of the gate 1220 (or the gate line), the overlapping area of the gate 1220 (or the gate line) and the source 1240 can be decreased, and in this way the capacitance value of the first capacitor C1 can be reduced, so as to still enable the gate driving circuit 1300 to normally drive the active device 1200 in the display area with the overall power consumption reduced.

In this embodiment, the overlapping width of the source 1240 of the active device 1200 and the width reduced gate 1220 of the active device 1200 is substantially larger than or equal to 60% of the overlapping width of the width reduced drain 1326 of the pull-up device 1320 and the gate 1322 of the pull-up device. Furthermore, the overlapping width of the source 1240 of the active device 1200 and the width reduced gate 1220 of the active device 1200 is substantially smaller than or equal to 90% of the overlapping width of the width reduced drain 1326 of the pull-up device 1320 and the gate 1322 of the pull-up device 1320.

Additionally, the line width of the width reduced gate 1220 of the active device 1200 substantially falls between 4 μm and 5 μm, while the line width of the width reduced drain 1326 of the pull-up device 1320 substantially falls between 5 μm and 6 μm.

Referring to FIG. 1, the scan line 1400 is disposed on the substrate 1100, and electrically connects the drain 1326 of the pull-up device 1320 and the gate 1220 of the active device 1200. In other words, the gate driving circuit 1300 of this embodiment can drive the active device 1200 through the scan line 1400.

It can be known based on the foregoing that, in this embodiment, when the pull-up device 1320 is designed, an actual layout thereof is as shown in FIG. 3B, that is, the overlapping area of the drain and the gate in the pull-up device for connecting the CLK can be reduced, thereby reducing the capacitance value of the capacitor with the highest power consumption during the driving, and in this way the power consumption can be reduced. Subsequently, in this embodiment, the capacitance value of the first capacitor C1 of the overlapping gate 1220 (or the gate line) and source 1240 in the display area can be reduced, and in this way the output demands for driving the active device 1200 can be reduced, that is, after reducing the overall power consumption of the gate driving circuit 1300, sufficient output capability still can be maintained to drive the active device 1200 in the display area P1. A layout for reducing the capacitance of the first capacitor C1 in the display area P1 is as shown in. FIG. 4, that is, the purpose of reducing the capacitance of the first capacitor C1 can be achieved by reducing the overlapping of the gate 1220 (or the gate line) and the source 1240.

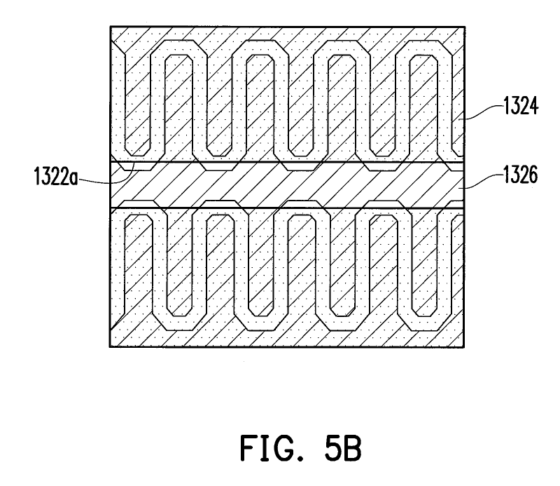

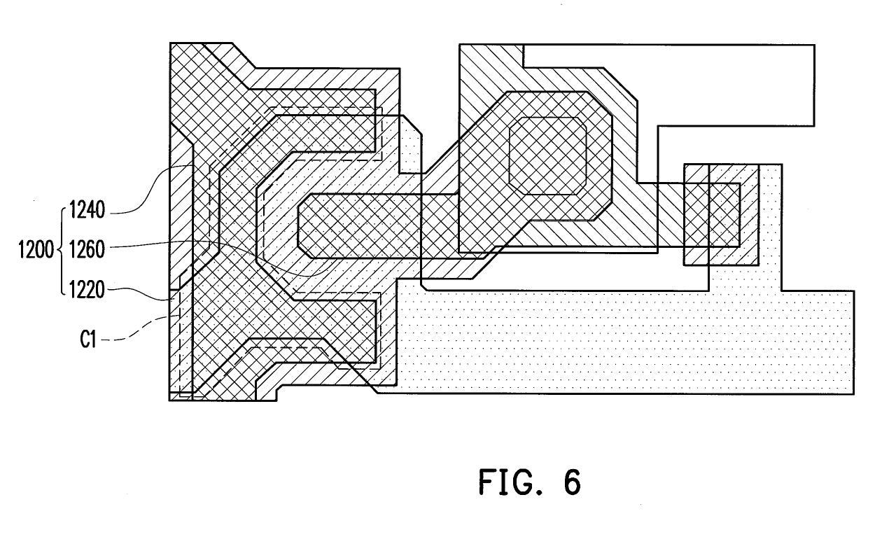

Additionally, in order to achieve the foregoing purpose, in this embodiment, a layout view as shown in FIG. 5B can also be adopted. Referring to FIG. 5A firstly, FIG. 5A shows a disposing manner of the gate 1322, the source 1324, and the drain 1326 of the conventional pull-up device, in which the film layer of the gate 1322 is provided below the drain 1326, so as to form the foregoing second capacitor C2. Likewise, in order to reduce the capacitance value of the second capacitor C2, the gate 1322 in FIG. 5A can be patterned to form a patterned gate 1322a in FIG. 5B, in which the overlapping area of the patterned gate 1322a and the drain 1326 is reduced, so in this way the capacitance value of the second capacitor C2 is reduced, and the overall power consumption of the gate driving circuit 1300 can also be reduced.

Furthermore, likewise, the capacitance value of the second capacitor C2 is reduced, so in order to enable the gate driving circuit 1300 to smoothly drive the active device 1200 in the display area P1, besides adopting the layout manner in FIG. 4 to reduce the capacitance value of the first capacitor C1 in the display area at this time, the layout view as shown in FIG. 6 can also be adopted.

Specifically, relative to the design of reducing the line width W2 of the gate 1220 adopted in FIG. 4, the layout view in FIG. 6 can reduce the capacitance value of the first capacitor C1 between the gate 1220 (or the gate line) and the source 1240 without reducing the line width W2 of the gate 1220, so as to reduce the output demands for driving the active device 1200. For example, by appropriately patterning the pattern of the source 1240, the overlapping area of the source 1240 and the gate 1220 can be decreased without the need of reducing the line width W2 of the gate 1220, so that the capacitance value of the first capacitor C1 between the gate 1220 (or the gate line) and the source 1240 can be reduced, as shown in FIG. 6.

In the embodiment of FIG. 5B and FIG. 6, the overlapping width of the source 1240 of the active device 1200 and the gate 1220 of the active device 1200 is substantially larger than or equal to 60% of the width of the gate 1220 of the active device 1200, and the overlapping width of the source 1240 of the active device 1200 and the gate 1220 of the active device 1200 is substantially smaller than or equal to 90% of the width of the gate 1220 of the active device 1200.

In other words, if the active device array substrate 1000 of FIG. 1 adopts the designed film layer as shown in FIG. 5B and FIG. 6, likewise, with the power consumption of the gate driving circuit 1300 being reduced, the mechanism for normally driving the active device 1200 still can be maintained.

Based on the foregoing, the present invention provides a method for reducing power consumption, which is applicable to the foregoing active device array substrate 1000. The method for reducing power consumption according to this embodiment includes the following steps. Firstly, the overlapping area of the drain 1326 of the pull-up device 1320 and the gate 1322 of the pull-up device 1320 is reduced, so as to reduce the capacitance of the second capacitor C2. Then, the overlapping area of the source 1240 of the active device 1200 and the gate 1220 of the active device 1200 is reduced, so as to reduce the capacitance of the first capacitor C1.

In an embodiment, the method for reducing the overlapping area of the drain 1326 of the pull-up device 1320 and the gate 1322 of the pull-up device 1320 can be implemented by reducing the line width of the drain 1326 of the pull-up device 1320. Furthermore, the method for reducing the overlapping area of the source 1240 of the active device 1200 and the gate 1220 (the gate line) of the active device 1200 can be implemented by reducing the line width of the gate 1220 (the gate line) of the active device 1200.

In another embodiment, the method for reducing the overlapping area of the drain 1326 of the pull-up device 1320 and the gate 1322 of the pull-up device 1320 can be further implemented by removing a part of the gate 1322 of the pull-up device 1320 (such as the implementation aspect as shown in FIG. 5B), so as to reduce the overlapping area of the drain 1326 of the pull-up device 1320 and the gate 1322 of the pull-up device 1320. In this embodiment, the method of reducing the overlapping area of the source 1240 of the active device 1200 and the gate 1220 of the active device 1200 can be implemented by reducing the line width of the gate 1220 of the active device 1200, or the method of reducing the overlapping area of the source 1240 of the active device 1200 and the gate 1220 of the active device 1200 is implemented through a patterning process.

In view of the above, the embodiment of the present invention can achieve at least one of the following effects. Firstly, the width of the drain of the pull-up device can be reduced, so that the overlapping area of the drain of the pull-up device and the gate of the pull-up device is reduced, and in this way the capacitance value of the second capacitor of the pull-up device is reduced, thereby reducing the overall power consumption of the gate driving circuit. At the same time, the capacitance value of the first capacitor can be reduced by reducing the overlapping area between the gate (or the gate line) of the active device and the source of the active device, so as to reduce the output demands for driving the active device. In other words, according to the present invention, by reducing the second capacitance value of the pull-up device, the overall power consumption of the gate driving circuit can be reduced, and at the same time of reducing the overall power consumption of the gate driving circuit, the capacitance value of the first capacitor of the active device in the display area is reduced, so that the gate driving circuit still can normally drive the active device in the display area.

Furthermore, a patterned gate can also be formed by patterning the gate of the pull-up device, so as to reduce the overlapping area of the patterned gate and the drain, and in this way the capacitance value of the second capacitor can also be reduced, so as to reduce the overall power consumption of the gate driving circuit. Meanwhile, by appropriately patterning the pattern of the source of the active device, the overlapping area of the source and the gate can be reduced without the need of reducing the line width of the gate of the active device, so as to reduce the capacitance value of the first capacitor between the gate (or the gate line) and the source to have the characteristics.

Based on the foregoing, the present invention also provides a method for reducing power consumption, which is applicable to the foregoing active device array substrate.

What is described in the foregoing is only exemplary embodiments of the present invention, and definitely is not intended to limit the scope of the present invention. It will be apparent to those skilled in the art that various modifications and variations can be made to the structure of the present invention without departing from the scope or spirit of the invention. Additionally, any embodiment or the claims of the present invention unnecessarily achieves all purposes or advantages or characteristics according to the present invention. Furthermore, the abstract and the title are only used for assisting in searching the patent document, and are not intended to limit the scope of the present invention.

What is claimed is:

1. An active device array substrate, comprising:
a substrate, defined a display area and a peripheral circuit area;
at least one active device, disposed on the substrate and located in the display area, wherein the active device comprises a width reduced gate, a source, and a drain, and an overlapping area of the source of the active device and the width reduced gate of the active device forms a first capacitor;
a gate driving circuit, disposed on the substrate and located in the peripheral circuit area, wherein the gate driving circuit comprises at least one pull-up device, the pull-up device comprises a gate, a source, and a width reduced drain, and an overlapping area of the width reduced drain of the pull-up device and the gate of the pull-up device forms a second capacitor; and
at least one scan line, disposed on the substrate and electrically connecting the drain of the pull-up device and the gate of the active device.

2. The active device array substrate according to claim 1, wherein the overlapping width of the source of the active device and the width reduced gate of the active device is substantially larger than or equal to 60% of the overlapping width of the width reduced drain of the pull-up device and the gate of the pull-up device, and the overlapping width of the source of the active device and the width reduced gate of the active device is substantially smaller than or equal to 90% of the overlapping width of the width reduced drain of the pull-up device and the gate of the pull-up device.

3. The active device array substrate according to claim 1, wherein the line width of the width reduced gate of the active device substantially falls between 4 μm and 5 μm, while the line width of the width reduced drain of the pull-up device substantially falls between 5 μm and 6 μm.

4. An active device array substrate, comprising:
a substrate, defined a display area and a peripheral circuit area;
at least one active device, disposed on the substrate and located in the display area, wherein the active device comprises a gate, a source, and a drain, and an overlapping area of the source of the active device and the gate of the active device forms a first capacitor;
a gate driving circuit, disposed on the substrate and located in the peripheral circuit area, wherein the gate driving circuit comprises at least one pull-up device, the pull-up device comprises a patterned gate, a source, and a drain, and an overlapping area of the drain of the pull-up device and the patterned gate of the pull-up device forms a second capacitor; and
at least one scan line, disposed on the substrate and electrically connecting the drain of the pull-up device and the gate of the active device,
wherein the overlapping width of the source of the active device and the gate of the active device is substantially larger than or equal to 60% of the width of the gate of the active device, and the overlapping width of the source of the active device and the gate of the active device is substantially smaller than or equal to 90% of the width of the gate of the active device.

5. A method for reducing power consumption, applicable to an active device array substrate, wherein the active device array substrate comprises at least one active device and a gate driving circuit, the active device is located in a display area of the active device array substrate, while the gate driving circuit is located in a peripheral circuit area of the active device array substrate; the active device comprises a gate, a source, and a drain, and an overlapping area of the source of the active device and the gate of the active device forms a first capacitor; the gate driving circuit comprises at least one pull-up device, the pull-up device comprises a gate, a source, and a drain, and an overlapping area of the drain of the pull-up device and the gate of the pull-up device forms a second capacitor, and the method for reducing power consumption comprises:
reducing the overlapping area of the drain of the pull-up device and the gate of the pull-up device, so as to reduce the capacitance of the second capacitor; and
reducing the overlapping area of the source of the active device and the gate of the active device, so as to reduce the capacitance of the first capacitor.

6. The method for reducing power consumption according to claim 5, wherein the method of reducing the overlapping area of the drain of the pull-up device and the gate of the pull-up device comprises:
reducing the line width of the drain of the pull-up device.

7. The method for reducing power consumption according to claim 6, wherein the method of reducing the overlapping area of the source of the active device and the gate of the active device comprises:
reducing the line width of the gate of the active device.

8. The method for reducing power consumption according to claim 7, wherein the overlapping width of the source of the active device and the gate of the active device is substantially larger than or equal to 60% of the overlapping width of the drain of the pull-up device and the gate of the pull-up device, and the overlapping width of the source of the active device and the gate of the active device is substantially smaller than or equal to 90% of the overlapping width of the drain of the pull-up device and the gate of the pull-up device.

9. The method for reducing power consumption according to claim 5, wherein the method of reducing the overlapping area of the drain of the pull-up device and the gate of the pull-up device comprises:
removing a part of the gate of the pull-up device, so as to reduce the overlapping area of the drain of the pull-up device and the gate of the pull-up device.

10. The method for reducing power consumption according to claim 9, wherein the method of reducing the overlapping area of the source of the active device and the gate of the active device comprises:
reducing the line width of the gate of the active device, or reducing the overlapping area of the source of the active device and the gate of the active device through a patterning process.

11. The method for reducing power consumption according to claim 10, wherein the overlapping width of the source of the active device and the gate of the active device is substantially larger than or equal to 60% of the width of the gate of the active device, and the overlapping width of the source of the active device and the gate of the active device is substantially smaller than or equal to 90% of the width of the gate of the active device.
